(19) United States
(12) Patent Application Publication
(10) Pub. No.: US 2009/0187847 A1
(43) Pub. Date: Jul. 23, 2009

(54) Operating System Providing Consistent Operations Across Multiple Input Devices

(75) Inventor: Paul Mercer, Palo Alto, CA (US)

Correspondence Address: FENWICK & WEST LLP, SILICON VALLEY CENTER, 801 CALIFORNIA STREET, MOUNTAIN VIEW, CA, 94041, US

(73) Assignee: Palm, Inc., Sunnyvale, CA (US)

(21) Appl. No.: 12/016,895

(22) Filed: Jan. 18, 2008

(51) Int. Cl. G06F 13/20; G06F 3/14

(52) U.S. Cl. 715/781; 710/6

(57) ABSTRACT

An operating system of a mobile computing device translates primitive input signal from an input device to a navigation message invoking a navigation operation at application programs. The navigation operation represents a unit of action (e.g., ‘select’ an item) intended by a user on an application program. Different input signals from different input devices are mapped to navigation messages at the operating system. The application program receives and processes the navigation message; and thus, the application program is relieved of tasks associated with processing primitive input signals. By providing the navigation messages from the operating system, consistent navigation operations can be achieved at different application programs, and application programmers can conveniently program application programs for computing devices with different hardware configurations.

### BACKGROUND

1. Field of Art

The present disclosure relates generally to operating an application program running on a mobile computing device, more specifically to delegating the operation generally associated with the application program to the operating system of the mobile computing device.

2. Description of the Related Art

Mobile computing devices such as a personal digital assistant (PDA), a smart phone, an MP3 player often use different user input devices. For example, some mobile computing devices employ a combination of a touchscreen and a number of buttons as their user input devices while other mobile computing devices employ keypads or touchscreens as their sole user input devices. In some cases, two or more input devices of the same mobile computing device allow the same operation to be performed on the mobile computing device. For example, to place a phone call in a smartphone, a user may press a designated key on the smartphone or touch an icon appearing on the touchscreen of the smartphone.

In conventional mobile computing devices, application programs are programmed to process primitive input messages from device drives and perform the operations as indicated by the input messages. In a mobile computing device using a touchscreen, for example, the operating system (specifically, the device drivers) installed on the mobile computing device translates physical input signals into primitive input event messages (e.g., key ‘a’ of keypad was pressed) that can be deciphered by application programs. Each application program includes codes or routines to receive the input event messages and perform operations according to the input event messages.

In conventional mobile computing devices, each application program must be programmed to receive and to respond to the input event messages. Although the device driver of the operating system translates physical input signals into the input event messages, each application program must include codes or routines to address input event messages associated with different device drivers. Also, different application developer may use different conventions to define which input event messages represent which operations on the application programs. This may lead to inconsistent definition of user inputs in different application programs which degrades the overall user experience of the mobile computing device.

Furthermore, the application programmer is burdened with including codes and routines to address different types of input devices. The application program developers must anticipate user input devices that may be used in the mobile computing devices, and provide routines and codes in each application program to address user inputs from different types of user input devices. The issue is exacerbated when a new type of user input device is developed and becomes integrated into the mobile computing device. When a new user input device becomes available, the application program developers must update the application programs individually to work in conjunction with the new user input device.

Therefore, among other deficiencies, the present art lacks schemes and methods that allow users to have a consistent experience in multiple application programs despite using different input devices to receive user inputs. Further, the present art also lacks a navigation scheme and methods that allows application programs to consistently interface with different types of user input devices.

### SUMMARY

Embodiments disclosed employ an operating system that translates a physical input signal from an input device to a navigation message representing a signal logically higher in level than the physical input signal and invoking a navigation operation at two or more application programs executable on the operating system. The navigation operation represents a unit of action (e.g., ‘select’ an item) intended by a user on an application program. The navigation operation may be an operation that is common to or applicable to two or more application programs. The operation system is delegated with the task of processing the low-level input signal into the high-level navigation message; and therefore, the application program is relieved of the task to address the low-level input signals.

In one embodiment, the navigation message invokes core navigation commands including, for example, selection of an item in the application program, activation of a selected item within the application program, returning to a state of the mobile computing device before activating a selected item, changing to a state of the mobile computing device where predetermined operations of the mobile computing device may be taken, and changing to a state where options for the application program can be set.

In one embodiment, the operating system comprises a core navigation module for mapping inputs from different input devices to the navigation messages. The core navigation module includes an input mapping table indicating which input signals from which input device should invoke which navigation operations. The core navigation module is used to consistently translate user inputs from different input devices into the navigation message for invoking the navigation operations at the application programs.

In one embodiment, the operating system defines a set of navigation messages. The first input signal of the first input device may be mapped to a first subset of the set of the navigation messages, and the second input signal of the second input device may be mapped to a second subset of the set of the navigation messages. The first subset of the navigation messages may overlap with the second subset of the navigation messages. By using different subsets of navigation messages for different input devices, the input devices may be customized to represent a number of navigation messages according to the capability and characteristics of the input devices.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

Embodiments disclosed can be readily understood by considering the following detailed description in conjunction with the accompanying drawings.

FIG. 1A is a drawing illustrating a first mobile computing device having a first hardware configuration, according to one embodiment.

FIG. 1B is a drawing illustrating a second mobile computing device having a second hardware configuration, according to one embodiment.

FIG. 2 is a block diagram illustrating the structure of mobile computing device according to one embodiment.

FIGS. 3A and 3B are block diagrams illustrating the process of generating screens images on mobile computing devices having different hardware configurations, according to one embodiment.

FIGS. 4A and 4B are block diagrams illustrating the process of navigating within or beyond an application program using user inputs received from input devices, according to one embodiment.

FIG. 5 is a diagram illustrating a core navigation module of an operation system, according to one embodiment.

FIG. 6 is a flowchart illustrating the method of using different input devices to perform navigation operations, according to one embodiment.

### DETAILED DESCRIPTION OF EMBODIMENTS

Embodiments of an operating system provide an environment where application programs need not address differences in input signals from different input devices. The operating system processes primitive input signals into high-level navigation messages indicating a navigation operation at application programs. The operating system provides the high-level navigation messages to the application programs instead of the primitive input signals; and thus, the application program is relieved of tasks associated with addressing idiosyncrasies in the primitive input signals from different input devices.

The mobile computing device refers to any portable computing device having at least one input device. The mobile computing device can be computing devices including, among others devices, a smartphone, a personal digital assistant (PDA), a game console, an MP3 player, and a mobile phone. The mobile computing device may also be referenced as a mobile client device or handheld computing device. The mobile client device includes at least a processor and a storage device for storing an operating system and an application program.

A physical input signal is a primitive signal generated by an input device of the mobile computing device. The physical input signal indicates physical changes in the input device including, among other changes, changes in the resistance or capacitance of an electronic component. In a keypad, for example, the physical input signal indicates whether a certain key was pressed by a user. In a touchscreen, for example, the physical input signal indicates which portion (vertical and horizontal coordinates) of the screen was touched by the user.

A navigation message refers to a message provided by an operating system to indicate a navigation operation intended by the user of the mobile computing device. The user of the mobile computing device provides user input to the input devices of the mobile computing device with an intention to cause certain events at the application programs. For example, when the user presses a ‘back’ key, the user's intention is not to cause an electrical signal from the key but to cause a navigation operation to return to a previous screen of the application program. The navigation message represents the user's such intention, i.e., invoking a navigation operation on the part of the application program. The number and types of navigation messages may vary depending on the mobile computer device. That is, the mobile computing device may use only a subset of the navigation messages provided by the operating system. Alternatively, the mobile computing device may provide navigation messages in addition to common navigation messages defined by the operating system.

### Example Mobile Computing Devices

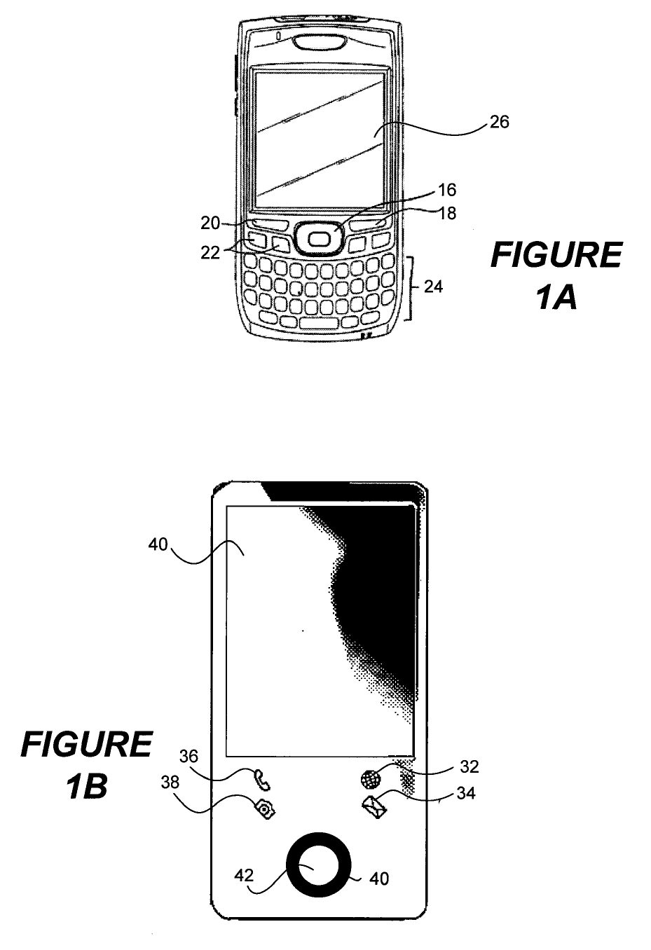

FIGS. 1A and 1B illustrate two mobile computing devices having different hardware configurations, according to embodiments of the present disclosure. FIG. 1A is an example of a smartphone having at least a touchscreen 26, a keypad 24, a five-way navigation key 16, and function buttons 18, 20, 22 as its user input devices. The keypads may be used for inputting alphanumeric characters while the five-way navigation key 16 may be used to navigate left, right, up, and down a menu or item in the application program. The center of the five-way navigation key 16 may be pressed to indicate selection of the item after navigating through the menu or item. The function keys 18, 20, 22 may be used to perform certain designated functions (e.g., options setting or launching of a web browser). The touchscreen 26 may be used to input data in conjunction with the keypad 24 or other keys 16, 18, 20, 22.

FIG. 1B is an example of a mobile phone that uses a touchscreen 40, function keys 32, 34, 36, 38, a scroll wheel 40, and a center button 42 as its input devices. Most of the user inputs may be provided by the touchscreen 40 while other input devices are dedicated to other essential functions. For example, The function keys 32, 34, 36, 38 may be used to perform designated functions such as placing of a call, launching of an internet browser, taking of a photo, or launching of an email program.

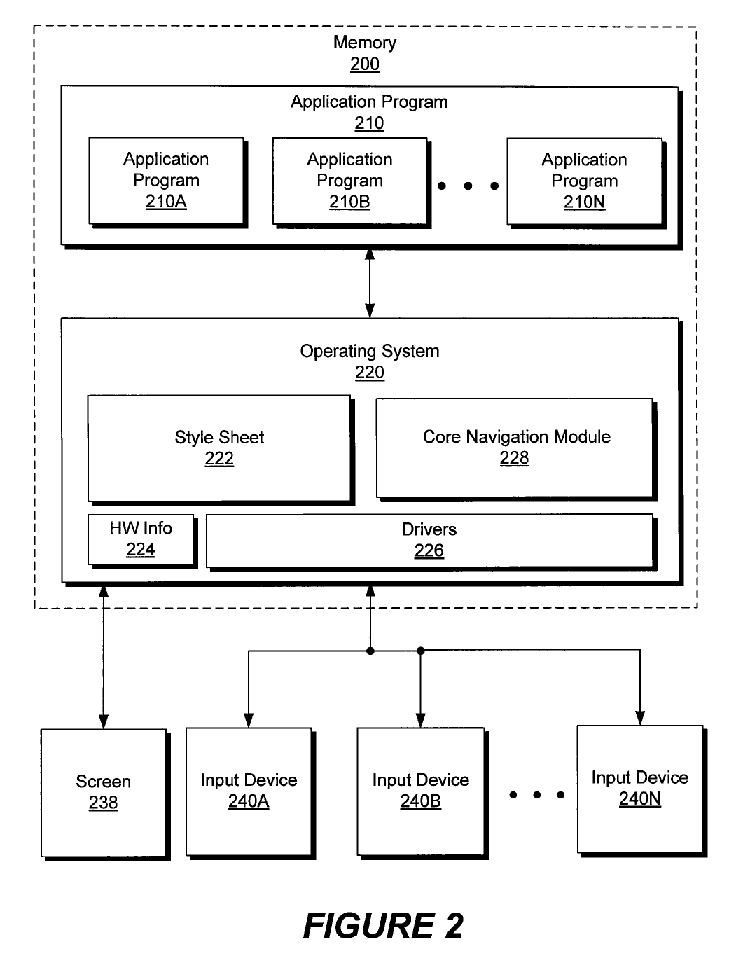

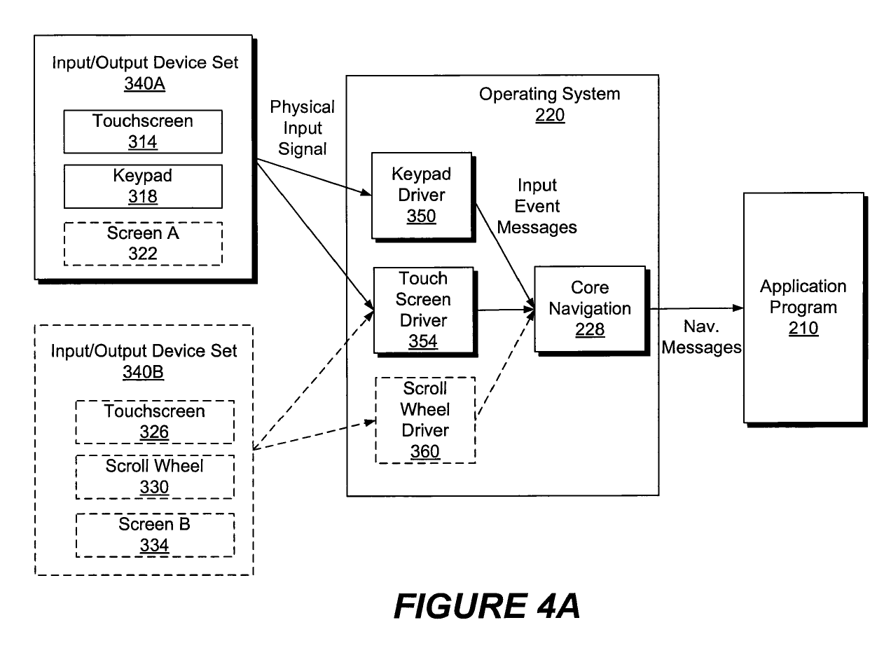

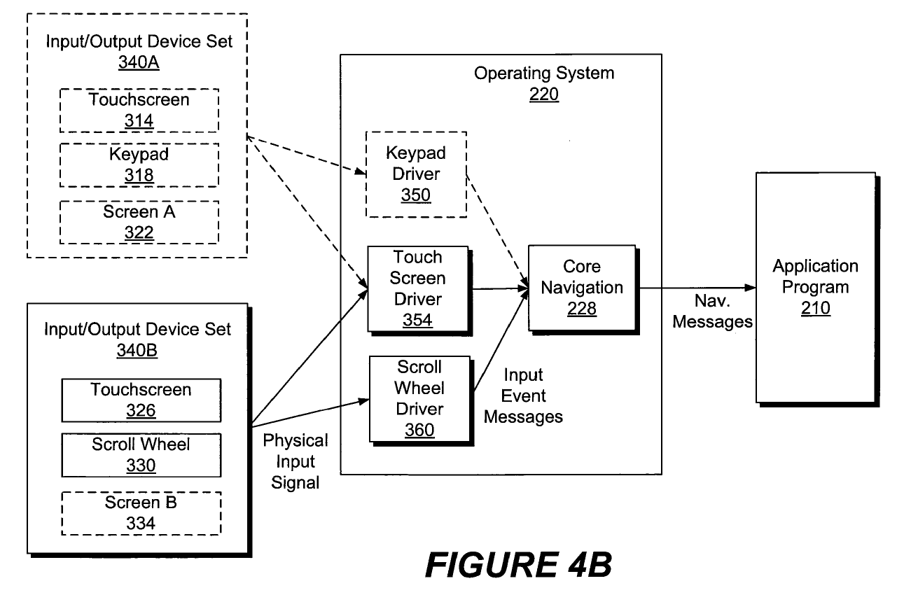

Both the smartphone of FIG. 1A and the mobile phone of FIG. 1B use the same operating system, as explained below in detail with reference to FIG. 2. The operating system installed on the smartphone of FIG. 1A and the mobile phone of FIG. 1B interacts with multiple user input devices but provides consistent high-level navigation messages, as explained below in detail with reference to FIGS. 4A and 4B. Specifically, the operating system on the smartphone of FIG. 1A handles user inputs from the touchscreen 26, the keypad 24, the five-way navigation key 16, and the function buttons 18, 20, 22 whereas the same operating system on the mobile phone of FIG. 1B handles user inputs from the touchscreen 40, the function keys 32, 34, 36, 38, the scroll wheel 40, and the center button 42.

The above examples of the mobile computing devices are merely to illustrate different input devices that may be incorporated into mobile computing devices. Various other types of input devices that may be used in the mobile computing devices include, among other devices, a mouse, a trackball, a keyboard, a joystick, a microphone for a voice command system or other input devices yet to be developed.

### Structure of Mobile Computing Device

FIG. 2 is a block diagram illustrating the components of mobile computing device, according to one embodiment. The mobile computing device of FIG. 2 includes, among other components, a processor (not shown), memory 200, a screen 238, and multiple input devices 240A-N. The input devices 240A-N may be various types of user input devices as described, for example, with reference to FIGS. 1A and 1B.

The processor is associated with the memory 200 to execute instructions for operating the mobile computing device. The memory 200 stores software components including an operating system 220 and application programs 210A-N (hereinafter collectively referred to as the application programs 210). The memory 200 can be implemented by various storage devices including, a flash memory device, a hard disk, a floppy disk, and Random Access Memory (RAM).

The operating system 220 manages the resources of the mobile computing device, and allows the application programs 210 to interact with the input devices 240A-N. The operating system 220 includes drivers 226, hardware information 224, a core navigation module 228, and a style sheet 222. As in conventional operating systems, each device driver is associated with a hardware component such as the screen 238 or the input device 240A-N to allow the application programs 210 to interact with the hardware components. Specifically, the device drivers associated with the input devices 240A-N translate physical input signals from input devices into primitive input event messages (e.g., key ‘a’ of keypad was pressed). In one or more embodiments, a multiple sequence of input event messages is mapped into a single navigation message. The input event messages are then translated by the core navigation module 228 to the navigation messages representing high-level navigation operations.

The hardware information 224 is managed by the operating system to indicate the current hardware configuration of the mobile computing device. The hardware information 224 may be automatically generated by the mobile computing device after detecting the hardware components installed on the mobile computing device. Alternatively, the hardware information 224 may be compiled and stored on the mobile computing device by the manufacture of the mobile computing device. In one embodiment, the hardware information 224 is referenced by the operating system 220 to determine the device drivers to be loaded, and the user input devices 240A-N to be mapped in the core navigation module 228.

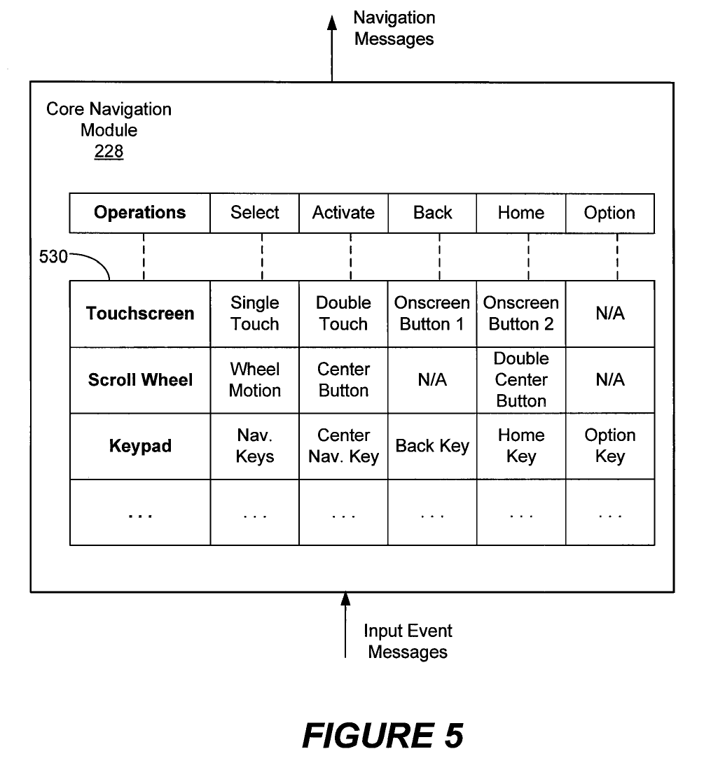

The core navigation module 228 provides the navigation messages to the application programs 210. In one embodiment, the core navigation module 228 maps user inputs from different input devices to the navigation messages, as described in detail below with reference to FIG. 5. The core navigation module 228 retrieves the navigation messages mapped to the input events signals and provides the navigation messages to the application programs 210 to prompt the navigation operations.

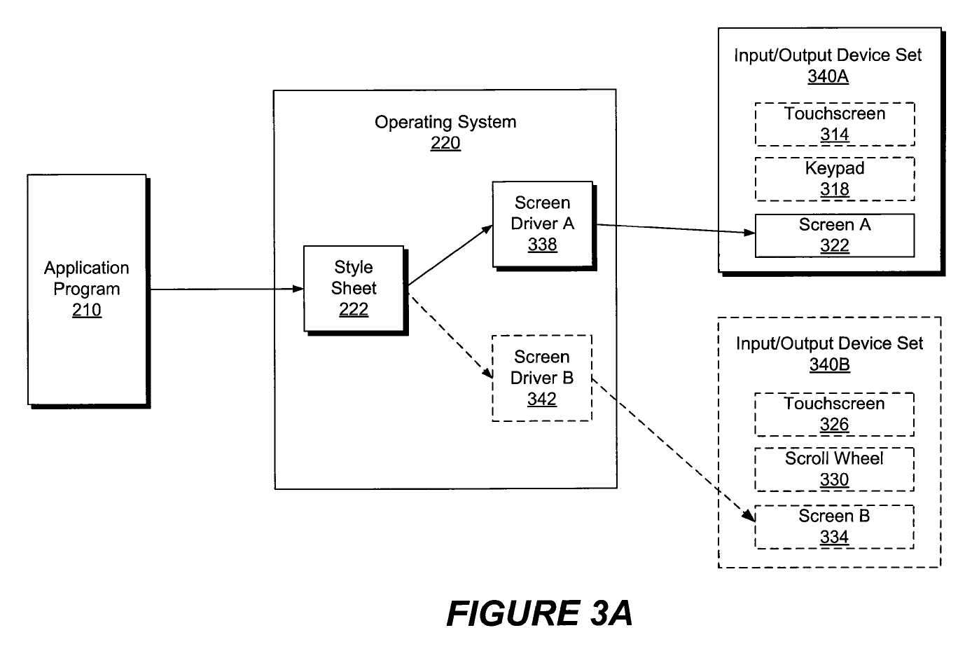

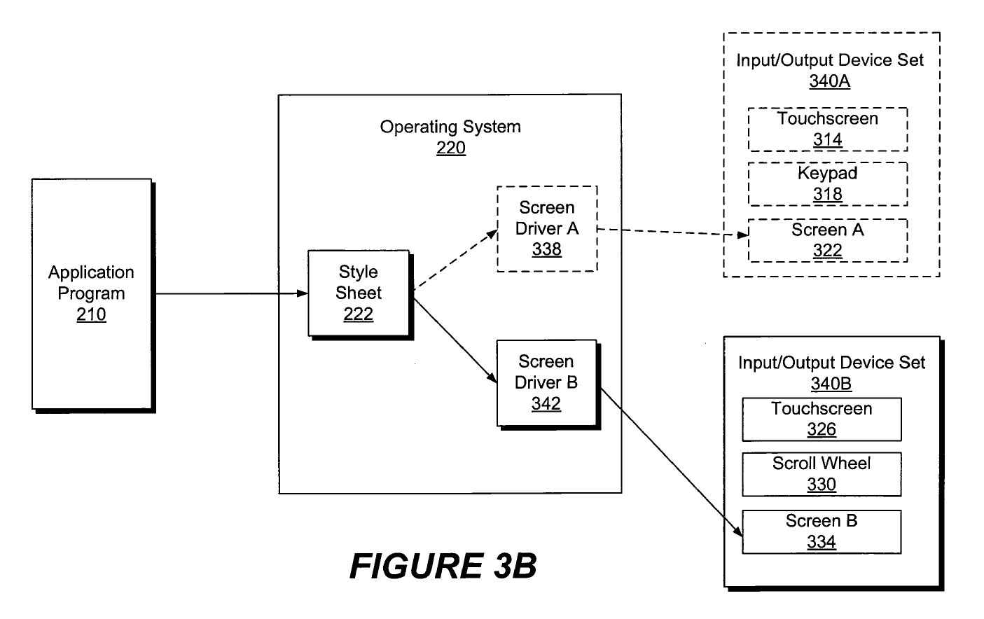

The style sheet 222 interacts with the application programs 210 to display screen images with consistent appearances on the display devices of the mobile computing device, as described below in detail with reference to FIGS. 3A and 3B.

### Navigation Messages and Navigation Operations

The navigation messages are distinct from the low-level input event messages provided by the drivers 226. The input event messages provided by the drivers 226 indicate certain user inputs from the user input devices and may not represent high-level navigation operations to be invoked at the application program. An input event message provided by the driver upon receiving a physical input signal does not represent certain navigation operations. The input event messages may be mapped by the application programs (in conventional methods) or by the core navigation module (in embodiments of this disclosure) to different operations, and therefore, the input event messages themselves may not represent certain navigation operations. In the mobile computing devices of the present disclosure, the input event messages are translated by the core navigation module 228 into the navigation messages. The navigation messages, contrary to the input event messages, represent navigation operations because the same navigation messages invoke the same navigation operation in multiple application programs 210 to the extent possible.

In one embodiment, the navigation messages indicate, among other operations, a ‘select’ operation, an ‘activation’ operation, a ‘back’ operation, a ‘home’ operation, and an ‘options’ operation. The ‘select’ operation allows the user to select an item of the application program through navigation. The ‘activation’ operation activates an item selected after navigating through menus or items of the application program. The ‘back’ operation indicates returning to a previous state within the application program (e.g., returning to a previous page or screen). The ‘home’ operation changes going to a specific screen in the operating system or the application program. The application programs of the mobile computing device can be organized into a tree structure where each branch of the tree structure represents different sets of operations. The ‘home’ operation allows the user to transition from one branch of operation to the root of the operation or another branch of operation. For example, the ‘home’ operation will allow the user to leave currently active application programs (e.g., a calendar program) and transition to a different axis of operation where predetermined operations such as placing a phone call or receiving a phone call may be performed. The ‘options’ operation allows the user to transition the application program to a state where certain user options for the application programs can be configured.

In another embodiment, the navigation messages further indicates zoom (relative zoom or zoom to a specific scale), scroll/panning, and directional flicking operations.

The number and types of operations to be represented by the navigation messages may differ depending on the type and application of the mobile computing device. In one embodiment, the navigation messages are provided for navigation operations that are essential to the operation of the application programs. In another embodiment, the navigation messages are defined exhaustively to include all the navigation operations that can be performed on the application programs.

### Output Operation of Example Mobile Computing Device

FIGS. 3A and 3B illustrate embodiments for generating output screen images on the display devices of the mobile computing device. In one embodiment, the application programs 210 use different visual elements (e.g., icons or alphanumeric characters) to generate the screen images on the display devices. By using the style sheet 222, the application programs 210A-N may generate screen images having consistent appearances on the display devices of the mobile computing device.

In one embodiment, an application program 210A sends codes that represent the visual elements to the style sheet 222. The style sheet 222 interprets the codes from the application program 210A and generates messages representing the visual elements to be displayed on the display devices. By using the style sheet 222, the visual elements may be rendered on the display devices in a consistent manner regardless of differences in the application programs 210 or hardware configurations of the display devices.

In the example of FIG. 3A, the mobile computing device (shown in solid lines) includes an input/output device set 340A. Specifically, the mobile computing device includes a touchscreen 314 and a keypad 318 as its input devices, and screen A 322 as its output device. After the application program 210 sends code (e.g., code indicating drawing of a ‘phone’ icon on the screen) representing the visual elements to the style sheet 222, the style sheet 222 translates the code into visual element messages (e.g., pixel information for the ‘phone’ icon). The visual element messages are sent to the screen driver A 338 to generate physical device signals to the screen A 322 that renders the screen images including the visual element on the screen A 322.

The mobile computing device of FIG. 3B (shown in solid lines) is essentially the same as the mobile computing device of FIG. 3A, except that the mobile computing device of FIG. 3B includes a different input/output device set 340B. Specifically, the input/output device set 340B includes a touchscreen 326, a scroll wheel 330, and screen B 334.

The screen B 334 may have different capability, characteristics or size compared to the screen A 322. The application programs 210 may display consistent screen images on the screen B despite the different capability or size of the screen because the style sheet 222 translates the code from the application program 210 into the visual element messages adapted to the screen B 334. Specifically, the style sheet 222 references the hardware information 224 to determine the capability, characteristics or size of the screen B. Then the style sheet 222 takes into account the different capability, characteristics or size of screens, and generates the visual element messages in a manner to allow the screen images in different screens to have similar appearances.

### Input Operation of Example Mobile Computing Device

FIGS. 4A and 4B illustrate embodiments of the mobile computing device for generating the navigation messages based on the physical input signals received from the input devices. The mobile computing device of FIG. 4A (shown in solid lines) is the same as the mobile computing device of FIG. 3A. FIG. 4A is merely a mirrored version of FIG. 3A illustrating the input process in the same mobile computing device (FIG. 3A illustrates the output process). As explained above with reference to FIG. 3A, the mobile computing device of FIG. 4A includes the touchscreen 314 and the keypad 318 as its user input devices.

The physical input signals from the input devices 314, 318 are translated to the input event messages by respective device drivers 350, 354. Specifically, the physical input signals from the touchscreen 314 are translated into the input event messages by the touchscreen driver 354. Similarly, the physical input signals from the keypad 318 are converted into the input event messages by the keypad driver 350. The scroll wheel driver 360 (shown in a box with dashed lines) is not active because the input/output device set 340A does not include a scroll wheel. The input event messages are provided to the core navigation module 228 to translate the input event messages to the navigation messages, as explained in detail below with reference to FIG. 5.

FIG. 4B illustrates an embodiment of the mobile computing device that is similar to the mobile computing device of FIG. 4A, except that the mobile computing device of FIG. 4B includes a scroll wheel 330 as its input device instead of the keypad 318 and the screen B 334 as its output device. The mobile computing device of FIG. 4B is a mirrored version of FIG. 3B illustrating the input process in the same mobile computing device (FIG. 3B illustrates the output process). In the embodiment of FIG. 4B, the scroll wheel driver 360 is active because the input/output device set 340B includes the scroll wheel 330. The keypad driver 350 is inactive (shown in a box with dashed lines) because the input/output device set 340B does not include a keypad.

As illustrated in FIGS. 4A and 4B, the core navigation module 228 translates the input event messages from different device drivers to provide the high-level navigation messages to the application programs 210. The navigation messages represent the navigation operations that are independent of specific input devices. Because the application program 210 interfaces with the input devices through the high-level navigation messages, the application program 210 does not need to address the idiosyncrasies in the input event messages from different input devices such as data types, frequency of the messages, and different information included in the input event messages.

The examples of FIGS. 4A and 4B are merely illustrative. Various other types of input devices may also be used. Also, the core navigation module 228 need not be a module separate from the drivers 350, 354, 360. In one embodiment, the core navigation module 228 may be combined with the drivers 350, 354, 360. Further, the core navigation module 228 need not be a module dedicated to translating the input event messages to the navigation messages. The core navigation module 228 may be part of other modules in the operation system (e.g., style sheet 222) that performs other operations in addition to the translation of the input event messages.

### Structure of Core Navigation Module

FIG. 5 is a schematic diagram illustrating the core navigation module 228, according to one embodiment. The core navigation module 228 is part of the operating system 220 that is responsible for translating the primitive input event messages into the high-level navigation messages. In one embodiment, the core navigation module 228 includes, among others, an input mapping table 530. After the one or more input event messages are received from the device drivers 350, 354, 360, the core navigation module 228 uses the input mapping table 530 to identify the navigation messages associated with the input event messages. Conventional algorithms or methods may be used to identify the navigation operation matching with the input event messages.

After identifying and retrieving the navigation message corresponding to the input event messages, the core navigation module 228 sends the navigation messages to the application program to invoke the navigation operations. In one embodiment, the core navigation module 228 modifies the navigation messages into a form that can be recognized by a particular application program receiving the navigation messages. For example, the core navigation module 228 may translate a navigation message not recognized by the application program into a sequence of navigation messages recognized by the application program.

In the example of FIG. 5, the input mapping table 530 includes multiple rows of entries, each row representing the user inputs associated with one input device (e.g., a touchscreen, a scroll wheel or a keypad). The columns of the input mapping table 530 indicate the user inputs of the input devices that cause the same navigation operations at the application programs. For example, a single touch of the touchscreen, a wheel turning finger-tip motion of the scroll wheel, and pressing of navigational keys (e.g., five-way navigational keys) all cause the ‘selecting’ navigation operation at the application program 210.

Some input devices may be associated with only a subset of the navigation operations that can be provided by the operating system 220. In the example of FIG. 5, the scroll wheel only provides the user inputs associated with the ‘selecting’ operation, the ‘activating’ operation, and the ‘home’ operation. Further, different input devices may be associated with different subsets of the navigation operations. For example, a touchscreen may be associated with only the ‘selecting’ operation and the ‘activation’ operation whereas a keypad may be associated with only ‘back’ operation, and ‘home’ operation. In one embodiment, the number and types of navigation messages that may be provided by the operating system is limited to the navigation messages that are applicable to two or more application programs. In another embodiment, the number and types of navigation messages that may be provided is limited to the navigation messages that are applicable to most, if not all, application programs.

Despite the differences in the input devices, the core navigation module 228 provides the high-level navigation messages to the application programs. Therefore, the application programs do not need to address the differences in the input signals from different input devices, and consistent operation across different computing devices can be achieved. The application program need not include codes and routines to address different types of input devices. Further, the core navigation module 228 may allow high-level navigation messages to be mapped from a complex sequence of input event messages, thereby allowing use of complex navigation operations otherwise too onerous for the application program to implement. Also, when new input devices become available and are integrated into the mobile computing device, only the core navigation module 228 needs to be updated as rather than modifying all of the application programs to accommodate the new input devices.

### Method of Navigating Using Core Navigation Module

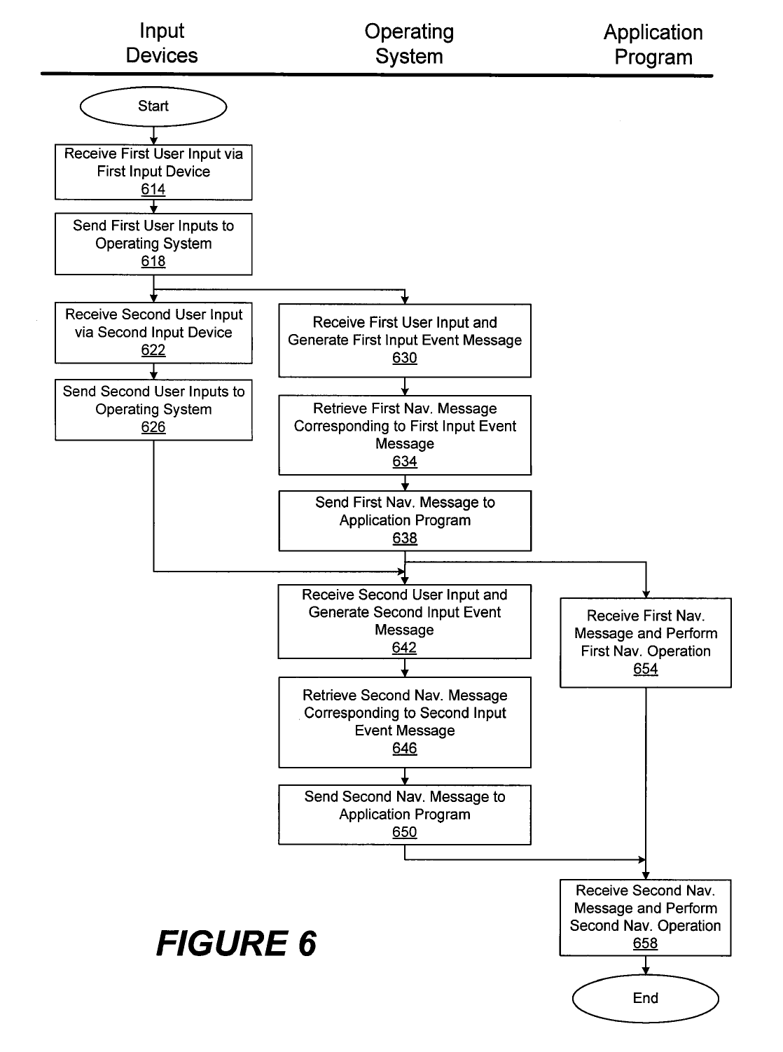

FIG. 6 is a flowchart illustrating the method of performing navigation operations at the application programs, according to one embodiment. First, a first user input is received 614 at the first input device (e.g., a keypad). The first input device then sends the physical input signal to the operating system 220. The operating system 220 (specifically, the device driver for the first input device) receives 630 the physical input signal, and generates a first input event message. The operating system 220 retrieves 634 a first navigation message from the core navigation module 230 and sends 638 the first navigation message to the application program 210. The application program 210 receives the first navigation messages and performs first navigation operation (e.g., ‘select’ operation) corresponding to the first navigation message.

After a second user input is received 622 at the second input device (e.g., a touchscreen), the second input device sends 626 the physical input signal to the operating system 220. The operating system 220 (specifically, the device driver for the second input device) receives 642 the physical input signal, and generates a second input event message. The operating system 220 retrieves 646 a second navigation message from the core navigation module 228 and sends 650 the second navigation message to the application program 210. The application program 210 receives 658 the second navigation message and performs a second navigation operation (e.g., ‘activate’ operation) corresponding to the second navigation message.

### Alternative Examples

In one embodiment, the device drivers may include information on mapping of the input event messages with the navigation messages. The information may be transferred to the core navigation module 228 when the device driver becomes active. In one embodiment, the information from device driver is used to insert a new row in the input mapping table 530. By taking advantage of the information in the device driver, the core navigation module 228 is automatically updated or changed when new input devices are coupled or integrate to the mobile computing device.

As noted above, embodiments may be configured as software elements or modules. The software may be processes (e.g., as described with reference to FIG. 6) that are written or coded as instructions using a programming language. Examples of programming languages may include C, C++, BASIC, Perl, Matlab, Pascal, Visual BASIC, JAVA, ActiveX, assembly language, machine code, and so forth. The instructions may include any suitable type of code, such as source code, object code, compiled code, interpreted code, executable code, static code, dynamic code, and the like. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application programming interfaces (API), instruction sets, computing code, computer code, code segments, computer code segments, words, values, symbols, or any combination thereof. The embodiments are not limited in this context.

Some embodiments may be implemented, for example, using any tangible computer-readable media, machine-readable media, or article capable of storing software. The media or article may include any suitable type of memory unit, memory device, memory article, memory medium, storage device, storage article, storage medium and/or storage unit, such as any of the examples described with reference to a memory. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

Also, use of the “a” or “an” are employed to describe elements and components of embodiments of the present invention. This was done merely for convenience and to give a general sense of the embodiments of the present invention. This description should be read to include one or at least one and the singular also includes the plural unless it is obvious that it is meant otherwise.

Embodiments of the present disclosure provide an environment where application programs are relieved of tasks for processing low-level input messages associated with different input devices. The low-level input messages are translated by the operating system to a high-level navigation message and then provided to the application programs. Advantageously, the codes in the application programs need not be changed to address different low-level input messages associated with different input devices. Also, consistent navigation operations within and beyond the application programs can be achieved because the same high-level navigation messages are used across different application programs.

Upon reading this disclosure, those of skill in the art will appreciate still additional alternative structural and functional designs for a system and a process for a providing navigation messages through the disclosed principles herein. Thus, while particular embodiments and applications have been illustrated and described, it is to be understood that the disclosed embodiments are not limited to the precise construction and components disclosed herein and that various modifications, changes and variations will be apparent to those skilled in the art may be made in the arrangement, operation and details of the method and apparatus of the present embodiments disclosed herein without departing from the spirit and scope as defined in the appended claims.

What is claimed is:

1. A mobile computing device comprising:
a first input device configured to generate a first input signal responsive to receiving a first user input;
an operating system associated with the first input device, the operating system configured to translate the first input signal to a navigation message associated with a plurality of application programs, the navigation message representing a signal logically higher in level than the first input signal and representing a navigation operation intended by a user on the plurality of application programs; and
an application module associated with the operating system for executing the plurality of application programs that perform the navigation operation as indicated by the navigation message.

2. The mobile computing device of claim 1, further comprising a second input device for generating a second input signal responsive to receiving a second user input, the operating system translating the second input signal to another navigation message, the plurality of application programs performing the navigation operation as indicated by the other navigation message.

3. The mobile computing device of claim 2, wherein the operating system comprises a core navigation module for mapping the first input signal and the second input signal to navigation messages.

4. The mobile computing device of claim 2, wherein the operating system stores a set of navigation messages, each navigation message invoking a different navigation operation at the plurality of application programs, the first input signal mapped to a first subset of the set of the navigation messages, and the second input signal mapped to a second subset of the set of the navigation messages.

5. The mobile computing device of claim 1, wherein the navigation operation comprises at least one operation selected from the group of: selecting an item of the application program, activating a selected item of the application program, returning to a state of the mobile computing device before activating a selected item, changing to a state of the mobile computing device where predetermined operations of the mobile computing device may be taken, and changing to a state for receiving configuring options.

6. The mobile computing device of claim 1, wherein the plurality of application programs do not include codes or routines for processing the first input signal from the first input device.

7. A method of processing user inputs for operation of a mobile computing device, the method comprising:
at a first input device, generating a first input signal responsive to receiving a first user input;
at an operating system, translating the first input signal to a navigation message associated with a plurality of application programs, the navigation message representing a signal logically higher in level than the first input signal and representing a navigation operation intended by a user on the plurality of application programs; and
at the plurality of application programs, performing the navigation operation as indicated by the navigation message.

8. The method of claim 7, further comprising generating a second input signal responsive to receiving a second user input at a second input device, the operating system translating the second input signal to another navigation message, and the plurality of application programs performing the navigation operation as indicated by the other navigation message.

9. The method of claim 8, wherein translating the first input signal to a navigation message comprises retrieving the navigation message corresponding to the first input signal from an input mapping table.

10. The method of claim 8, wherein the operating system maps the first input signal to a first set of navigation messages, and maps the second input signal to a second set of the navigation messages

11. The method of claim 7, wherein the navigation operation comprises at least one operation selected from the group of: selecting an item of the application program, activating a selected item of the application program, returning to a state of the mobile computing device before activating a selected item, changing to a state of the mobile computing device where predetermined operations of the mobile computing device may be taken, and changing to a state for receiving configuring options.

12. The method of claim 7, wherein the plurality of application programs do not perform processing of the first input signal.

13. A computer program product comprising a computer readable storage medium structured to store instructions executable by a processor in a mobile client device, the instructions, when executed cause the processor to:
receive, at the operating system, a first input signal from a first user input responsive to a first user input;
translate, at the operating system, the first input signal to a navigation message associated with a plurality of application programs, the navigation message representing a signal logically higher in level than the first input signal and representing a navigation operation intended by a user on the plurality of application programs; and
perform, at the plurality of application programs, the navigation operation as indicated by the navigation message.

14. The computer program product of claim 13, further comprising instructions to:
receive, at the operating system, a second input signal responsive to receiving a second user input at a second input device;
translate, at the operating system, the second input signal to another navigation message; and
perform, at the plurality of application programs, the navigation operation as indicated by the other navigation message.

15. The computer program produce of claim 14, wherein the instructions to translate the first input signal to a navigation message comprise instructions to retrieve the navigation message corresponding to the first input signal from an input mapping table.

16. The computer program product of claim 13, wherein the navigation operation comprises at least one operation selected from the group of: selecting an item of the application program, activating a selected item of the application program, returning to a state of the mobile computing device before activating a selected item, changing to a state of the mobile computing device where predetermined operations of the mobile computing device may be taken, and changing to a state for receiving configuring options.

17. The computer program product of claim 13, wherein the plurality of application programs do not include instructions to perform processing of the first input signal.

18. A mobile computing device comprising:
a first input device configured to generate a first input signal responsive to receiving a first user input;
an operating system associated with the first input device, the operating system configured to translate the first input signal to a navigation message associated with a plurality of application programs, the navigation message representing a signal logically higher in level than the first input signal and representing at least one navigation operation selected from the group of: selecting an item of the application program, activating a selected item of the application program, returning to a state of the mobile computing device before activating a selected item, changing to a state of the mobile computing device where predetermined operations of the mobile computing device may be taken, and changing to a state for receiving configuring options; and
an application module associated with the operating system for executing the plurality of application programs that perform the navigation operation as indicated by the navigation message, the plurality of application programs not including codes or routines for processing the first input signal.

19. The mobile computing device of claim 18, further comprising a second input device for generating a second input signal responsive to receiving a second user input, the operating system translating the second input signal to another navigation message, the plurality of application programs performing the navigation operation as indicated by the other navigation message.

20. The mobile computing device of claim 18, the operating system is further configured to provide screen images associated with the plurality of application programs at a display device of the mobile computing device, the screen images having consistent appearances.
